(19) United States
(12) Patent Application Publication
(10) Pub. No.: US 2026/0064877 A1
(43) Pub. Date: Mar. 5, 2026

(54) MANAGING DATA PRIVACY COMPLIANCE FOR DATA PROCESSING SYSTEMS USING OUT-OF-BAND METHODS

(71) Applicant: Dell Products L.P., Round Rock, TX (US)

(72) Inventors: MOHIT ARORA, Frisco, TX (US); LUIS ANTONIO VALENCIA REYES, Waxahachie, TX (US); VINODKUMAR VASUDEV OTTAR, McKinney, TX (US); ABEYE TESHOME, Austin, TX (US); RICHARD M. TONRY, Georgetown, TX (US); BASSEM EL-AZZAMI, Austin, TX (US); ADOLFO SANDOR MONTERO, Pflugerville, TX (US); RAJARAVI CHANDRA KOLLARAPU, Allen, TX (US)

(21) Appl. No.: 18/820,691

(22) Filed: Aug. 30, 2024

(51) Int. Cl. G06F 21/62

(52) U.S. Cl. CPC G06F 21/6245

(57) ABSTRACT

Methods and systems for managing a data processing system are disclosed. A management controller of the data processing system may request privacy data for a user of the data processing system from a remote system via an out-of-band communication channel. The privacy data may indicate limits on use of data subject to privacy regulations to be enforced on hardware resources of the data processing system while the hardware resources are unable to natively enforce the privacy regulations. The management controller may obtain (e.g., via the out-of-band communication channel) the privacy data from the remote system, and may enforce compliance on the hardware resources with respect to the privacy regulations during operation of the hardware resources in which native compliance with the privacy regulations is not met.

### FIELD

Embodiments disclosed herein relate generally to managing data processing systems. More particularly, embodiments disclosed herein relate to systems and methods to manage operation of the data processing systems in view of data privacy regulations.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1A shows a block diagram illustrating a distributed system in accordance with an embodiment.

FIG. 1B shows a block diagram illustrating a data processing system in accordance with an embodiment.

FIGS. 2A-2B show interaction diagrams in accordance with an embodiment.

FIG. 3 shows a flow diagram illustrating a method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing a data processing system. The data processing system may provide computer-implemented services. To provide the computer-implemented services, hardware resources of the data processing system may use data subject to data privacy regulations (e.g., regulated data). For example, the regulated data may include information usable to identify a user of the data processing system. Violation of the privacy regulations may reduce a quality of the computer-implemented services, and the violation may be associated with negative outcomes, such as fines and/or other legal consequences.

To comply with the privacy regulations, privacy data (e.g., information indicating limits on use of the regulated data, such as user settings) may be provided by a user of the data processing system, and operation of the hardware resources (e.g., the data processing system) may be managed in accordance with limits indicated by the privacy data. However, the hardware resources may be unable to natively enforce the privacy regulations. For example, the privacy data may be unavailable to the hardware resources, and/or the privacy data may be inadequate (e.g., stale, compromised). For example, if the hardware resources are unable to access up-to-date and/or authentic privacy data for the user prior to performing privacy implicating processes, then the hardware resources may perform the privacy implicating processes in a manner that violates the privacy regulations.

Thus, to improve enforcement of the privacy regulations, the privacy data may be managed and/or stored by a trusted remote system (e.g., a service system). The privacy data may be obtained (e.g., verified) prior to performance of privacy implicating processes, and portions of the privacy implicating process may be managed (e.g., modified) to improve compliance with respect to the privacy data. To do so, the data processing system may include out-of-band components (e.g., a management controller) that may operate independently from in-band components (e.g., the hardware resources) of the data processing system.

The out-of-band components may manage operation of the in-band components. For example, a management controller may include functionality for managing power distribution to the hardware resources, and for communicating with the trusted remote system. The out-of-band components may communicate with the trusted remote system via secure out-of-band communication channels that service the out-of-band components separately from in-band communication channels that service the in-band components. Therefore, the out-of-band components may request and obtain up-to-date and authentic privacy data for the user regardless of a state of the hardware resources (e.g., an unpowered state, a compromised state).

In addition, the out-of-band components may manage enforcement of the privacy regulations. For example, the management controller may include functionality for modifying execution flows for performance by the hardware resources so that the execution flows are performed in accordance with user settings of the privacy data. By doing so, compliance of the (operation of the) hardware resources with the privacy regulations may be improved, which may result in improved (e.g., secure, reliable) computer-implemented services.

In an embodiment, a method for managing a data processing system is provided. The method may include: requesting, by a management controller of the data processing system and via an out-of-band communication channel, privacy data for a user of the data processing system from a remote system, the privacy data indicating limits on use of data subject to privacy regulations to be enforced on hardware resources of the data processing system while the hardware resources are unable to natively enforce the privacy regulations; obtaining, by the management controller and via the out-of-band communication channel, the privacy data from the remote system; and, enforcing, by the management controller, compliance of the hardware resources with the privacy regulations during operation of the hardware resources in which native compliance with the privacy regulations is not met.

The method may further include, prior to requesting the privacy data: identifying, by the data processing system, the privacy data for the user; and, initiating, by the data processing system, storage of the privacy data by the remote system. The privacy data may be provided to the remote system by the management controller using the out-of-band communication channel.

Enforcing the compliance may include modifying, by the management controller, an execution flow of a startup process for the hardware resources based on the privacy data. The hardware resources of the data processing system may be unable to natively modify the execution flow based on the privacy data.

Modifying the execution flow may include inserting, by the management controller, instructions into the execution flow, the instructions being usable for obtaining the privacy data from the user prior to the startup process using the data subject to the privacy regulations.

Modifying the execution flow may include inserting, by the management controller, instructions into the execution flow, the instructions being usable to exclude a portion of the startup process from being performed, the portion of the startup process using the data subject to the privacy regulations in a manner that violates the privacy regulations.

Modifying the execution flow may include inserting, by the management controller, instructions into the execution flow, the instructions being usable to cause the user to be informed that the privacy data is potentially stale, and request authorization from the user to complete the startup process.

The data processing system may include a network module adapted to separately advertise network endpoints for the management controller and the hardware resources, the network endpoints being usable by the remote system to address communications to the hardware resources and the management controller.

The out-of-band communication channel may run through the network module, and an in-band communication channel that services the hardware resources may also run through the network module.

The management controller and the network module may be on separate power domains from the hardware resources so that the management controller and the network module are operable while the hardware resources are inoperable. The requesting and the obtaining may be performed while the hardware resources are inoperable due to being unpowered.

A non-transitory media may include computer instructions that when executed by a processor cause the computer-implemented method to be performed.

The data processing system may include the non-transitory media and a processor, and may perform the computer-implemented method when the computer instructions are executed by the processor.

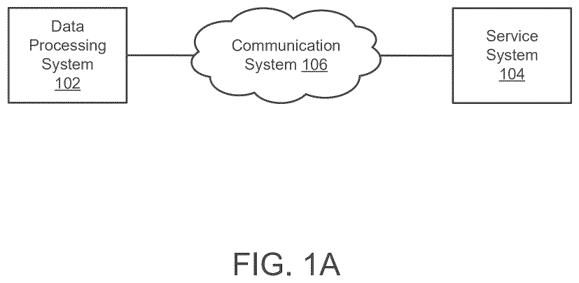

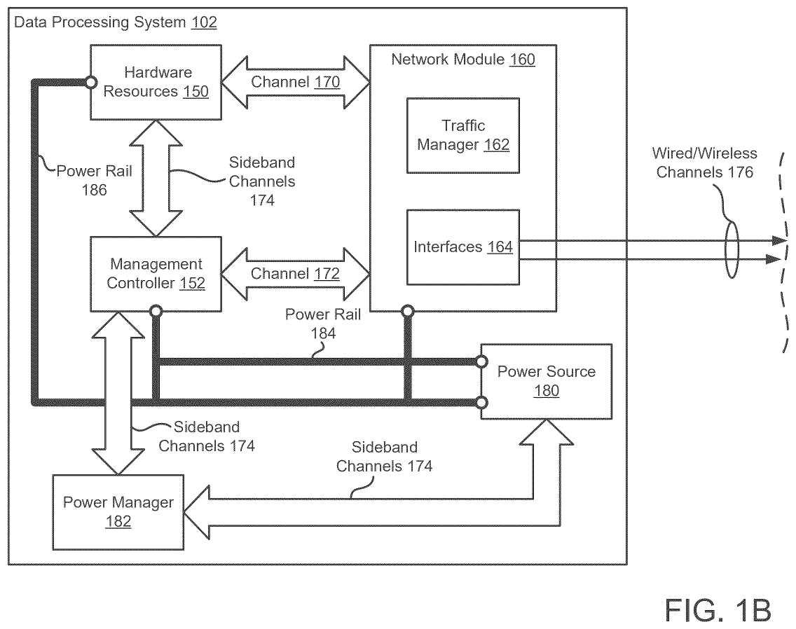

Turning to FIG. 1A, a block diagram illustrating a distributed system in accordance with an embodiment is shown. The system shown in FIG. 1A may provide computer-implemented services. The computer-implemented services may include any type and quantity of computer-implemented services. For example, the computer-implemented services may include communication services, data storage services, database services, data generation services, and/or any other type of service that may be implemented with a computing device.

To provide the computer-implemented services, the distributed system may use data that is subject to data privacy regulations (e.g., regulated data). For example, the regulated data may include any type of data usable (e.g., in isolation and/or in combination with other information) to identify a person such as a user of the data processing system. The (data) privacy regulations may define acceptable (e.g., legal) use of the regulated data, and may vary based on a type of the regulated data, geographical location (e.g., by state, by country, by continent), and/or other factors. A violation of the privacy regulations may reduce a quality (e.g., reliability, trustworthiness) of the computer-implemented services, and/or may result in penalties (e.g., fines) for an entity managing the data processing system and/or facilitating the computer-implemented services.

To enforce compliance with the privacy regulations, for example, a user of the data processing system may provide privacy data that indicates limits on use of the regulated data with respect to the privacy regulations (e.g., the user may consent to and/or limit certain types of use of the regulated data). While providing the computer-implemented services, a management entity hosted by hardware resources of the data processing system (e.g., an operating system) may manage operation of the hardware resources in accordance with the privacy data so that any use of (e.g., access of, sharing of) the regulated data is not in violation of the privacy regulations.

However, the hardware resources may be unable to natively enforce the privacy regulations. For example, during startup of the data processing system, software and/or firmware (e.g., a Basic Input/Output System (BIOS)) may invoke processes that use the regulated data prior to handing off operation of the hardware resources to the management entity (e.g., prior to obtaining adequate privacy data). Therefore, privacy implicating processes performed in a pre-operating system environment may violate the privacy regulations.

For example, a startup execution flow may include processes such as component verification, during which information usable to identify the user may be shared (e.g., hardware component identifiers, Internet Protocol (IP) addresses, medium access control (MAC) addresses). The startup execution flow may be hard-coded and/or fixed (e.g., unalterable), and therefore may include processes that, when performed natively, violate the privacy regulations. In addition, the privacy regulations and/or the privacy data may change over time and/or based on other factors. Therefore, during the startup of the data processing system, the privacy regulations may not be natively enforced by the hardware resources.

In general, embodiments disclosed herein may provide methods, systems, and/or devices for managing a data processing system in a manner that improves enforcement of data privacy regulations. To do so, the data processing system may include out-of-band components that operate independently from in-band components (e.g., the hardware resources) of the data processing system. The out-of-band components may include functionality for secure communication with a trusted remote system tasked with managing privacy data for a user of the data processing system.

The out-of-band components may use out-of-band communication channels to obtain up-to-date privacy data for the user from the trusted remote system, which may be more secure than using in-band communication channels that service the hardware resources. The out-of-band components may also include functionality for enforcing limits imposed on regulated data used by the data processing system as indicated by the privacy data, even while the hardware resources are in an undesired (e.g., inoperable, compromised) state.

By doing so, access to reliable (e.g., up-to-date, authentic) privacy data may be improved, so that when limits indicated by the privacy data are enforced, the data processing system may be more likely to operate in compliance with privacy regulations than when relying on in-band methods (e.g., using hardware resources and in-band communication channels).

To provide the above-mentioned functionality, the distributed system of FIG. 1A may include data processing system 102, service system 104, and communication system 106. The distributed system, any components thereof, and/or any other types of devices or components not shown in FIG. 1A may perform all, or a portion of the computer-implemented services independently and/or cooperatively. Each of these components is discussed below.

Data processing system 102 may include any number of data processing systems. Data processing system 102 may be operated directly or indirectly (e.g., via other devices) by any number of users. For example, a user may operate data processing system 102 to obtain computer-implemented services, and the computer-implemented services may use data subject to data privacy regulations. Data privacy policies of (e.g., stored by, accessible by, generated by) data processing system 102 may be enforced while providing the computer-implemented services. The data privacy policies may be based on the data privacy regulations.

Data processing system 102 may include hardware and/or software components. For example, data processing system 102 may include hardware resources such as a network card that includes functionality for obtaining and/or reporting data indicating a location of data processing system 102 (e.g., location data for data processing system 102) to other hardware resources, to out-of-band components, and/or to remote systems. For example, the location data may be used to determine which data privacy policies are to be enforced.

To manage policy enforcement, data processing system 102 may include out-of-band components, such as a management controller. The management controller may be capable of exchanging data with other devices (e.g., remote systems) via out-of-band communication channels. The management controller may operate independently from the hardware resources. The management controller may manage operation of portions of the hardware resources when enforcing policies of data processing system 102. Refer to the discussion of FIG. 1B for more information regarding components of data processing system 102.

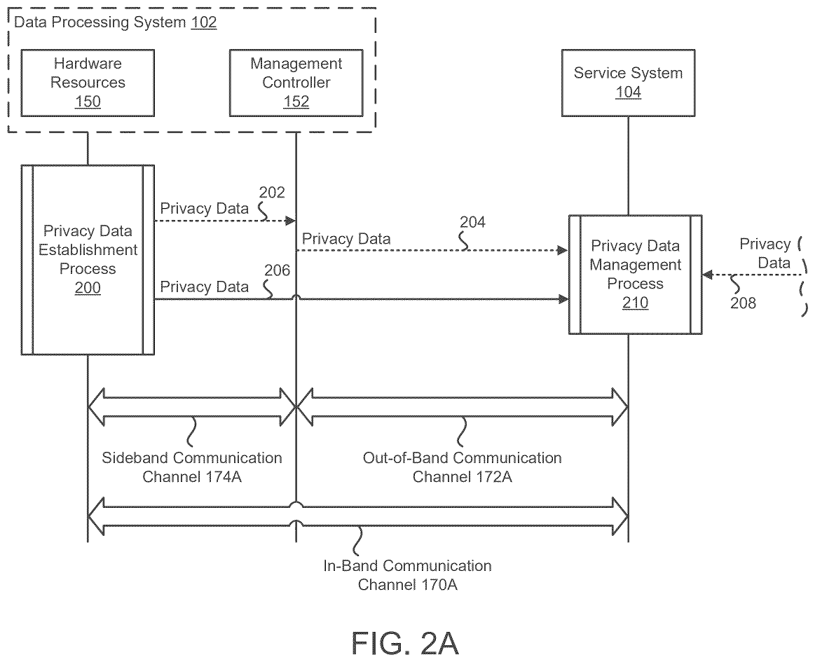

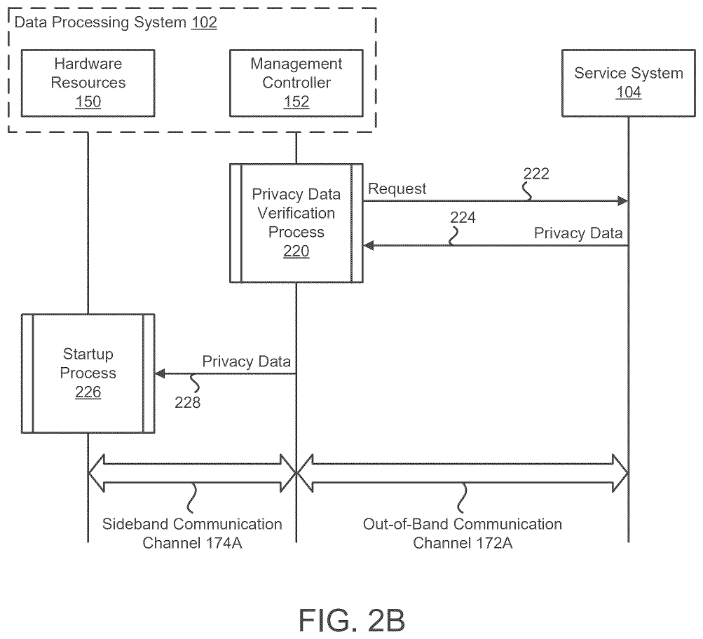

To provide the above-mentioned functionality, the management controller may, for example, (i) identify policies of data processing system 102 (e.g., based on location data for data processing system 102), (ii) request and/or obtain privacy data for users of data processing system 102 (e.g., from a trusted remote system such as service system 104), (iii) enforce compliance of the hardware resources with the policies (e.g., privacy regulations) based on the privacy data, and/or (iv) perform other actions relating to managing operation of data processing system 102. For example, to enforce compliance of the hardware resources with the policies, management controller may modify execution flows queued for performance by the hardware resources based on the privacy data. Refer to the discussion of FIG. 2B for more details regarding data privacy policy enforcement.

To facilitate establishment of the privacy data, data processing system 102 may (i) identify the privacy data for the user, and (ii) initiate storage of the privacy data by a trusted remote system, such as service system 104. Refer to the discussion of FIG. 2A for more details regarding privacy data establishment.

Service system 104 may include any number of systems that provide computer-implemented (e.g., Cloud) services for data processing system 102. For example, service system 104 may include a system trusted by data processing system 102 to provide secure data management services for data processing system 102. To perform the services, service system 104 may communicate and/or exchange data with components of data processing system 102 (e.g., the management controller via out-of-band communication channels and/or the hardware resources via in-band communication channels).

For example, service system 104 may (i) obtain privacy data for a user of data processing system 102 (e.g., from the hardware resources, from the management controller, and/or from other devices), (ii) store (backups of) the privacy data, (iii) obtain requests for privacy data, (iv) respond to the requests for privacy data (e.g., by providing copies of the requested privacy data to requesting devices), and/or (v) perform other actions for managing the privacy data (e.g., synchronizing up-to-date privacy data with the management controller and/or other devices in accordance with data synchronization policies).

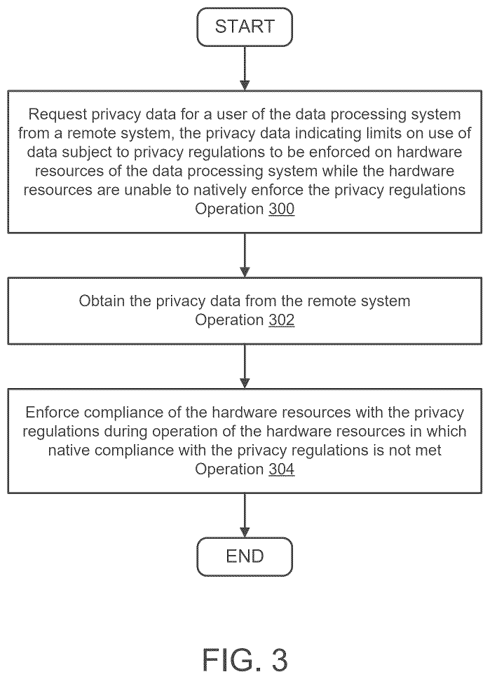

When providing their functionality, any of data processing system 102, service system 104, and/or components thereof may perform all, or a portion of the actions and methods illustrated in FIGS. 2A-3.

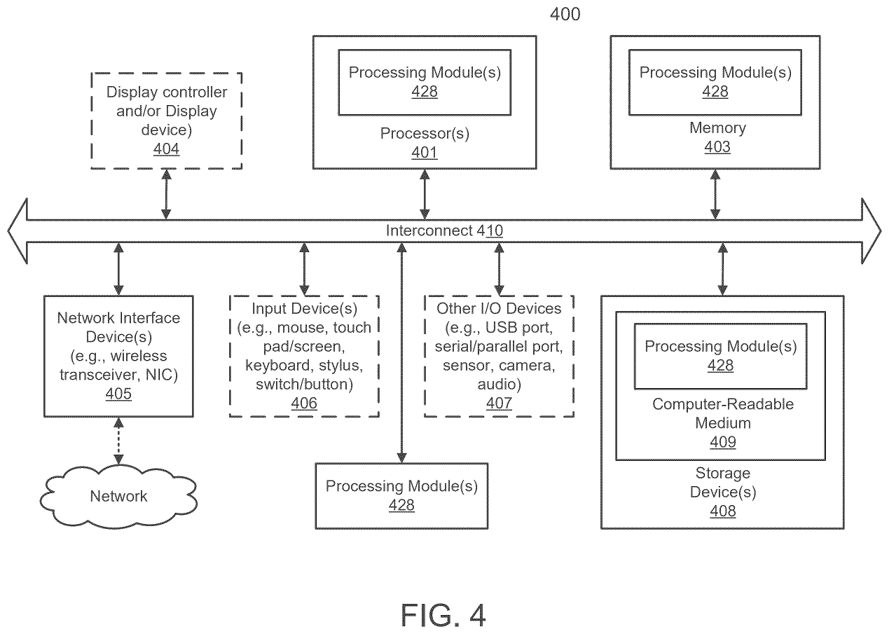

Any of data processing system 102 and service system 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., smartphone), an embedded system, local controllers, an edge node, and/or any other type of data processing device or system. For additional details regarding computing devices, refer to the discussion of FIG. 4.

Any of the components illustrated in FIG. 1A may be operably connected to each other (and/or components not illustrated) with communication system 106. Communication system 106 may facilitate communications between the components of FIG. 1A. In an embodiment, communication system 106 includes one or more networks that facilitate communication between any number of components. The networks may include wired networks and/or wireless networks (e.g., and/or the Internet). The networks and communication devices may operate in accordance with any number and types of communication protocols (e.g., such as the Internet protocol).

While illustrated in FIG. 1A as including a limited number of specific components, a system in accordance with an embodiment may include fewer, additional, and/or different components than those illustrated therein.

Turning to FIG. 1B, a diagram illustrating a data processing system in accordance with an embodiment is shown. Data processing system 102 shown in FIG. 1B may be similar to any of the computing devices shown in FIG. 1A.

To provide computer-implemented services, data processing system 102 may include any quantity of hardware resources 150. Hardware resources 150 may be in-band (hardware) components, and may include a processor operably coupled to memory, storage, and/or other hardware components.

The processor may host various management entities such as operating systems, drivers, network stacks, and/or other software entities that provide various management functionalities. For example, the operating system and drivers may provide abstracted access to various hardware resources. Likewise, the network stack may facilitate packaging, transmission, routing, and/or other functions with respect to exchanging data with other devices.

For example, the network stack may support transmission control protocol/internet protocol communication (TCP/IP) (e.g., the Internet protocol suite) thereby allowing the hardware resources 150 to communicate with other devices via packet switched networks and/or other types of communication networks.

The processor may also host various applications that provide the computer-implemented services. The applications may utilize various services provided by the management entities and use (at least indirectly) the network stack to communicate with other entities.

However, use of the network stack and the services provided by the management entities may place the applications at risk of indirect compromise. For example, if any of these entities trusted by the applications are compromised, then these entities may subsequently compromise the operation of the applications. For example, if various drivers and/or the communication stack are compromised, then communications to/from other devices may be compromised. If the applications trust these communications, then the applications may also be compromised.

For example, to communicate with other entities, an application may generate and send communications to a network stack and/or driver, which may subsequently transmit a packaged form of the communication via channel 170 to a communication component, which may then send the packaged communication (in a yet further packaged form, in some embodiments, with various layers of encapsulation being added depending on the network environment outside of data processing system 102) to another device via any number of intermediate networks (e.g., via wired/wireless channels 176 that are part of the networks).

To reduce the likelihood of the applications and/or other in-band entities from being indirectly compromised, data processing system 102 may include management controller 152 and network module 160. Each of these components of data processing system 102 is discussed below.

Management controller 152 may be implemented, for example, using a system on a chip or other type of independently operating computing device (e.g., independent from the in-band components, such as hardware resources 150 of a host data processing system 102). Management controller 152 may provide various management functionalities for data processing system 102. Management controller 152 may, for example, monitor various ongoing processes performed by the in-band components, may manage power distribution, thermal management, and/or may perform other functions for managing data processing system 102. For example, management controller 152 may monitor activity of hardware resources 150 in order to detect establishment of privacy data for a user of data processing system 102 (refer to FIG. 2A).

To do so, management controller 152 may be operably connected to various components via sideband channels 174 (in FIG. 1B, a limited number of sideband channels are included for illustrative purposes, it will be appreciated that management controller 152 may communicate with other components via any number of sideband channels such as sideband communication channel 174A shown in FIGS. 2A-2B). The sideband channels may be implemented using separate physical channels, and/or with a logical channel overlay over existing physical channels (e.g., logical division of in-band channels, such as in-band communication channel 170A of FIG. 2A).

The sideband channels may allow management controller 152 to interface with other components and implement various management functionalities such as, for example, general data retrieval (e.g., to snoop ongoing processes), telemetry data retrieval (e.g., to identify a health condition/other state of another component), function activation (e.g., sending instructions that cause the receiving component to perform various actions such as displaying data, adding data to memory, causing various processes to be performed), and/or other types of management functionalities.

For example, when managing policy enforcement for data processing system 102, management controller 152 may use sideband channels 174 to modify an execution flow of hardware resources 150 in order to prevent hardware resources 150 from operating in a manner that violates compliance with data privacy policies.

To reduce the likelihood of indirect compromise of an application hosted by hardware resources 150, management controller 152 may, for example, enable information from other devices to be provided to the application without traversing the network stack and/or management entities of hardware resources 150. To do so, the other devices may direct communications including the information to management controller 152.

Management controller 152 may then, for example, send the information via sideband channels 174 to hardware resources 150 (e.g., to store it in a memory location accessible by the application, such as a shared memory location, a mailbox architecture, or other type of memory-based communication system) to provide it to the application. Thus, the application may receive and act on the information without the information passing through potentially compromised entities. Consequently, the information may be less likely to also be compromised, thereby reducing the possibility of the application becoming indirectly compromised. Similarly, processes may be used to facilitate outbound communications from the applications.

Management controller 152 may be operably connected to communication components of data processing system 102 via separate channels (e.g., 172, 172A shown in FIGS. 2A-2B) from the in-band components, and may implement or otherwise utilize a distinct and independent network stack (e.g., TCP/IP). Consequently, management controller 152 may communicate with other devices independently of any of the in-band components (e.g., does not rely on any hosted software, hardware components, etc.). Accordingly, compromise of any of hardware resources 150 and hosted components may not result in indirect compromise of any management controller 152, and entities hosted by management controller 152.

To facilitate communication with other devices, data processing system 102 may include network module 160. Network module 160 may generate location data and/or provide communication services for in-band components and out-of-band components (e.g., management controller 152) of data processing system 102. To do so, network module 160 may include traffic manager 162, and interfaces 164.

Traffic manager 162 may include functionality to (i) discriminate traffic directed to various network endpoints advertised by data processing system 102, and (ii) forward the traffic to/from the entities associated with the different network endpoints. For example, to facilitate communications with other devices, network module 160 may advertise different network endpoints (e.g., different media access control address/internet protocol addresses) for the in-band components and out-of-band components. Thus, other entities may address communications to these different network endpoints. When such communications are received by network module 160, traffic manager 162 may discriminate and direct the communications accordingly (e.g., over channel 170 or channel 172, in the example shown in FIG. 1B, it will be appreciated that network module 160 may discriminate traffic directed to any number of data units and direct it accordingly over any number of channels).

Accordingly, traffic directed to management controller 152 may never flow through any of the in-band components. Likewise, outbound traffic from the out-of-band component may never flow through the in-band components.

For example, when communicating with a remote system (e.g., service system 104), messages from the remote system may be addressed to a network endpoint advertised by network module 160 for out-of-band communications. The messages may include, for example, privacy data for a user of data processing system 102 and/or other information. When messages are received by traffic manager 162, traffic manager 162 may forward the message to management controller 152 via an out-of-band communication channel (e.g., channel 172), differentiating the message from in-band communications to data processing system 102. By doing so, data processing system 102 may be more likely to obtain the privacy data even when hardware resources 150 are compromised and/or inoperable. Similarly, messages sent from management controller 152 (e.g., including requests for privacy data) to the remote system may be transmitted via the out-of-band communication channel to network module 160, bypassing the in-band components.

To support inbound and outbound traffic, network module 160 may include any number of interfaces 164. Interfaces 164 may be implemented using any number and type of communication devices which may each provide wired and/or wireless communication functionality. For example, interfaces 164 may include a wireless wide area network (WWAN) card, a Wi-Fi card, a wireless local area network card, a wired local area network card, an optical communication card, and/or other types of communication components. These components may support any number of wired/wireless channels 176.

To generate location data, network module 160 may include a location component (not shown). The location component may include a global positioning system (GPS) receiver (e.g., for satellite-based geolocation), a cellular modem or chip (e.g., for cellular-based geolocation using a WWAN), sensors, and/or other types of geolocation components. The location component may, for example, transmit and/or receive data across a network via interfaces 164 in order to generate (e.g., triangulate) a location of data processing system 102. The location data may be forwarded by traffic manager 162 to management controller 152 via an out-of-band communication channel (e.g., channel 172), bypassing potentially compromised and/or unavailable hardware resources 150.

Thus, location data for data processing system 102 may be generated and/or provided by network module 160 independently from hardware resources 150 (e.g., and software hosted by hardware resources 150). Network module 160 may provide the location data to management controller 152 automatically based on a schedule, upon (automatic) detection of a change in location data (e.g., based on a displacement threshold), and/or upon obtaining a request for location data (e.g., from management controller 152).

Management controller 152 may use the location data, for example, to identify a location for data processing system 102, and any location-based policies (e.g., data privacy policies keyed to different geographical regions) that are to be enforced over time.

Thus, from the perspective of an external device, the in-band components and out-of-band components of data processing system 102 may appear to be two independent network entities that may be independently addressable and/or otherwise unrelated to one another.

To facilitate management of data processing system 102 over time, hardware resources 150, management controller 152 and/or network module 160 may be positioned in separately controllable power domains. By being positioned in these separate power domains, different subsets of these components may remain powered while other subsets are unpowered.

For example, management controller 152 and network module 160 may remain powered while hardware resources 150 is unpowered. Consequently, management controller 152 may remain able to communicate with other devices even while hardware resources 150 are inactive. Similarly, management controller 152 may perform various actions while hardware resources 150 are not powered and/or are otherwise inoperable, unable to cooperatively perform various process, are compromised, and/or are unavailable for other reasons.

Therefore, regardless of a state of hardware resources 150, the out-of-band components may remain powered in order to enforce policies for data processing system 102. For example, while hardware resources 150 are unpowered, power distribution may be managed so that management controller 152 may still (i) obtain location data for data processing system 102, (ii) identify policies for enforcement (e.g., based on the location data), (iii) request and/or obtain privacy data from remote systems, and/or (iv) perform other actions for enforcing policies for data processing system 102 (e.g., provide privacy data to the remote systems).

To implement the separate power domains, data processing system 102 may include a power source (e.g., 180) that separately supplies power to power rails (e.g., power rail 184, power rail 186) that power the respective power domains. Power from the power source (e.g., a power supply, battery, etc.) may be selectively provided to the separate power rails to selectively power the different power domains. A power manager (e.g., 182) may manage power from power source 180, supplied via the power rails (e.g., by providing instructions via sideband channels 174). Management controller 152 may cooperate with power manager 182 to manage supply of power to these power domains. Management controller 152 may communicate with power manager 182 via sideband channels 174 and/or via other means.

In FIG. 1B, an example implementation of separate power domains using power rails 184-186 is shown. The power rails may be implemented using, for example, bus bars or other types of transmission elements capable of distributing electrical power. While not shown, it will be appreciated that the power domains may include various power management components (e.g., fuses, switches, etc.) to facilitate selective distribution of power within the power domains.

To further clarify embodiments disclosed herein, interaction diagrams in accordance with an embodiment are shown in FIGS. 2A-2B. The interaction diagrams may illustrate how data may be obtained and used within the system of FIGS. 1A-1B.

In the interaction diagrams, processes performed by and interactions between components of a (distributed) system in accordance with an embodiment are shown. In the diagrams, components of the system are illustrated using a first set of shapes (e.g., 150, 152, etc.), located towards the top of each figure. Lines descend from these shapes. Processes performed by the components of the system are illustrated using a second set of shapes (e.g., 200, 204) superimposed over these lines.

Interactions (e.g., communication, data transmissions, etc.) between the components of the system are illustrated using a third set of shapes (e.g., 202, 206) that extend between the lines. The third set of shapes may include lines terminating in arrows that may indicate one-way interactions (e.g., data transmission from a first component to a second component). Some of the third set of shapes are drawn in dashing to indicate that corresponding interactions are optional and/or may not occur (e.g., 202, 204).

Thick arrows (e.g., in-band communication channel 170A, sideband communication channel 174A, out-of-band communication channel 172A) may indicate communication channels that facilitate multi-way interactions (e.g., data transmission between two components).

Generally, the processes and interactions are temporally ordered in an example order, with time increasing from the top to the bottom of each page. For example, the interaction labeled as 202 may occur prior to the interaction labeled as 206. However, it will be appreciated that the processes and interactions may be performed in different orders, any may be omitted, and other processes or interactions may be performed without departing from embodiments disclosed herein.

Turning to FIG. 2A, a first interaction diagram in accordance with an embodiment is shown. The first interaction diagram may illustrate processes and interactions that may occur during establishment of privacy data for a user of a data processing system. The data processing system (e.g., data processing system 102) may include hardware resources 150, management controller 152, and/or other components (not shown).

To establish the privacy data (e.g., to create new privacy data and/or to update existing privacy data) for the user, the user may provide information regarding limits on use of data (e.g., regulated data) by data processing system 102 and/or other entities. For example, the information may indicate the user limits (and/or user agreement to) various types of use of the data during operation of data processing system 102. The privacy data may be based on laws and/or regulations of a geographical area (e.g., in which the user and/or data processing system 102 are present). Therefore, the privacy data may include privacy data regarding regulations for multiple geographical locations in which different data privacy policies for data processing system 102 are enforced.

In a first example of establishing the privacy data, the privacy data for the user may be identified by data processing system 102 during privacy data establishment process 200. Privacy data establishment process 200 may be performed by hardware resources 150 (e.g., using software hosted thereon). Privacy data establishment process 200 may be performed during normal operation of data processing system 102 and/or during special operation of data processing system 102 (e.g., during a special startup process for data processing system 102).

During privacy data establishment process 200, the user may be presented with an interface (e.g., a command line interface (CLI), a graphical user interface (GUI)) for providing user input regarding limits on data use. The privacy data may be a data structure that includes the user input and/or other information (e.g., policies and/or geographical locations associated with the privacy data, identifiers for data processing system 102 and/or the user, time-stamp information, cryptographically verifiable information). In other words, the privacy data may indicate user settings (e.g., limits) regarding use of data subject to privacy regulations that are to be enforced on hardware resources 150.

During privacy data establishment process 200, hardware resources 150 may store the privacy data (e.g., in a storage component of hardware resources 150) and/or may provide the privacy data to other entities. For example, hardware resources 150 may provide the privacy data to management controller 152 at interaction 202 and/or to service system 104 at interaction 206. By providing the privacy data to management controller 152 and/or service system 104, data processing system 102 may initiate storage of the privacy data by service system 104.

At interaction 202, the privacy data may be provided to management controller 152 by hardware resources 150 over sideband communication channel 174A via (i) transmission via a message, (ii) storing in a storage with subsequent retrieval by management controller 152, (iii) a publish-subscribe system where management controller 152 subscribes to updates from hardware resources 150 thereby causing a copy of the privacy data to be propagated to management controller 152, and/or (iv) other processes.

Alternatively, management controller 152 may identify establishment of the privacy data for the user (e.g., based on snooped activity of hardware resources 150, via sideband communication channel 174A), and may retrieve a copy of the privacy data from storage of hardware resources 150 (e.g., via sideband communication channel 174A).

Upon obtaining the privacy data, management controller 152 may perform various actions depending on privacy data policies for data processing system 102 that may be keyed to various circumstances. For example, management controller 152 may (i) store a time-stamped copy of the privacy data locally (e.g., when management controller 152 is unable to establish a secure connection with service system 104), and/or (ii) provide the privacy data to service system 104 (e.g., when hardware resources 150 is unable to do so). For example, hardware resources 150 may be unable to provide the privacy data to service system 104 when hardware resources 150 is not connected to a network via in-band communication channel 170A and/or in other circumstances where hardware resources 150 may not be reliable for providing the privacy data to service system 104 (e.g., when an in-band network connection is not secure, when hardware resources 150 are compromised).

At interaction 204, management controller 152 may provide the privacy data to service system 104 over out-of-band communication channel 172A via (i) transmission via a message, (ii) storing in a storage with subsequent retrieval by service system 104, (iii) a publish-subscribe system where service system 104 subscribes to updates from management controller 152 thereby causing a copy of the privacy data to be propagated to service system 104, and/or (iv) other processes.

By transferring the privacy data using out-of-band methods, the privacy data may be more likely to be securely provided to service system 104, regardless of a compromised and/or inoperable state of hardware resources 150. However, when hardware resources 150 are operable, connected to a secure network, and/or uncompromised, hardware resources 150 may provide the privacy data to service system 104 directly (e.g., not via management controller 152).

At interaction 206, hardware resources 150 may provide the privacy data to service system 104 over in-band communication channel 170A via (i) transmission via a message, (ii) storing in a storage with subsequent retrieval by service system 104, (iii) a publish-subscribe system where service system 104 subscribes to updates from hardware resources 150 thereby causing a copy of the privacy data to be propagated to service system 104, and/or (iv) other processes.

In a second example of establishing the privacy data, the privacy data for the user may be established by the user using a device other than data processing system 102. For example, the user may provide user input to an application hosted by service system 104 running on the device. The application may package the user input and/or other information to obtain the privacy data, and the privacy data may be provided to service system 104 (e.g., via the application and/or by other means) at interaction 208.

By providing the privacy data to service system 104, service system 104 may perform data management services for data processing system 102. Service system 104 may obtain any quantity of privacy data for management and/or storage (e.g., over time, as the privacy data for the user is updated by the user). To manage the privacy data, service system 104 may perform privacy data management process 210. During privacy data management process 210, service system 104 may, for example, track different versions of privacy data obtained over time (e.g., based on time stamp information), and compare copies of the privacy data (e.g., obtained from various entities) in order to validate the privacy data.

During privacy data management process 210, service system 104 may update a database of privacy data for any number of users and/or data processing systems. For example, service system 104 may store the privacy data (e.g., obtained at interactions 204, 206, and/or 208) and/or may update the database to reflect storage of the privacy data. The database may be used to manage and/or respond to requests for privacy data for the user.

Turning to FIG. 2B, a second interaction diagram in accordance with an embodiment is shown. The second interaction diagram may illustrate processes and interactions that may occur when enforcing compliance on a data processing system (e.g., 102) with data privacy regulations. One or more policies (e.g., data privacy policies) for the data processing system may be based on the data privacy regulations; therefore, enforcement of the data privacy policies may include enforcement of the data privacy regulations.

To enforce the data privacy regulations, management controller 152 may perform privacy data verification process 220. During privacy data verification process 220, management controller 152 may identify a policy of data processing system 102 that is to be enforced. For example, multiple data privacy policies may exist for data processing system 102, and each data privacy policy may be keyed to a different geographical region (e.g., and each data privacy policy may be defined in accordance with laws and/or regulations of the associated geographical region). Therefore, to identify the policy for enforcement, management controller 152 may, for example, analyze location data (e.g., obtained from a network module of data processing system 102) with respect to predefined geographical regions. A data privacy policy may be identified for enforcement by management controller 152.

The data privacy policy may be enforced based on privacy data obtained from a user of data processing system 102. During privacy data verification process 220, management controller 152 may obtain the privacy data for the user. For example, management controller 152 may obtain (e.g., generate) a request for the privacy data. The request may include a message indicating that the privacy data is being requested, identifying information (e.g., for data processing system 102, management controller 152, and/or the user), and/or other information (e.g., a location of data processing system 102, information regarding the data privacy policy, cryptographic information usable to verify authenticity of the request).

At interaction 222, the request may be provided to service system 104 by management controller 152. For example, the request may be provided to service system 104 over out-of-band communication channel 172A via (i) transmission via a message, (ii) storing in a storage with subsequent retrieval by service system 104, (iii) a publish-subscribe system where service system 104 subscribes to updates from management controller 152 thereby causing a copy of the request to be propagated to service system 104, and/or (iv) other processes. By providing the request to service system 104, service system 104 may provide privacy data management services for data processing system 102.

For example, service system 104 may use information included in the request to identify the privacy data being requested. The privacy data being requested may be associated with data processing system 102, the location of data processing system 102, the data privacy policy, and/or the user. Thus, service system 104 may, for example, query a database using the information included in the request to identify appropriate (e.g., up-to-date, relevant to the enforcing the data privacy policy) privacy data for the user.

Service system 104 may also manage data privacy policies for data processing system 102. For example, as data privacy regulations evolve over time, service system 104 may obtain and/or provide (e.g., push) updated data privacy policies to management controller 152. Therefore, the privacy data may also include a data privacy policy. Once identified, service system 104 may package a copy of the appropriate privacy data as well as other information (e.g., cryptographically verifiable information, data privacy policies) to obtain the (requested) privacy data.

At interaction 224, the privacy data may be provided to management controller 152 by service system 104. For example, the privacy data may be provided to management controller 152 over out-of-band communication channel 172A via (i) transmission via a message, (ii) storing in a storage with subsequent retrieval by management controller 152, (iii) a publish-subscribe system where management controller 152 subscribes to updates from service system 104 thereby causing a copy of the privacy data to be propagated to management controller 152, and/or (iv) other processes. By providing the privacy data to management controller 152, management controller 152 may continue performing privacy data verification process 220.

By requesting and/or obtaining the privacy data using out-of-band methods, the privacy data may be reliably requested and/or obtained while hardware resources 150 are unavailable (e.g., inoperable due to being unpowered), and/or compromised. When hardware resources 150 are unavailable and/or compromised, the privacy data may be stored locally with management controller 152.

Management controller 152 may initiate and/or perform privacy data verification process 220 (e.g., request and/or obtain privacy data from service system 104), for example, (i) in response to a privacy implicating process being initiated, performed, and/or queued for execution by hardware resources 150, (ii) based on data management policy being triggered, and/or (iii) in other situations and/or based on other triggers. For example, the data management policy may define stale (e.g., expired, out-of-date) privacy data for the user, and management controller 152 may respond to an identification of stale privacy data by requesting and/or obtaining up-to-date privacy data from service system 104 using out-of-band methods.

During privacy data verification process 220, management controller 152 may (i) verify (e.g., validate authenticity of) the privacy data, (ii) store the privacy data locally and/or in hardware resources 150 (e.g., via sideband communication channel 174A, not shown), and/or (iii) perform other actions relating to management of the privacy data.

The privacy data may indicate limits on use of data subject to data privacy regulations to be enforced on hardware resources 150. Therefore, as discussed with respect to FIG. 1B, management controller 152 may monitor activity of hardware resources 150 (e.g., processes initiated, performed, and/or queued for execution by portions of hardware resources 150) to identify privacy implicating processes (e.g., potential non-compliance of hardware resources 150 with the privacy regulations).

In the example shown in FIG. 2B, hardware resources 150 may perform a privacy implicating process such as startup process 226. During startup process 226, (i) hardware resources 150 may be inventoried, (ii) various programs may be loaded and begin to execute, (iii) various configurations for the hardware and/or software components may be set and/or verified, and/or (iv) other actions (e.g., processes) may be performed to complete startup process 226. Startup process 226 may result in eventual handoff to a management entity of data processing system 102 (e.g., an operating system).

The processes performed during startup process 226 may be non-configurable and/or limited in configurability; therefore, hardware resources 150 may be unable to natively enforce the data privacy regulations (e.g., in accordance with limitations indicated by the privacy data). For example, during startup process 226, information usable to identify the user may be used (e.g., accessed, shared with other entities), such as identifiers for components of data processing system 102, a MAC address, an IP address, and/or other information or characteristics regarding hardware and/or software components of data processing system 102 that may be used to identify a person (e.g., the user) in isolation and/or in combination with other information.

Therefore, to enforce the data privacy policy during startup process 226, management controller 152 may provide the privacy data to hardware resources 150 during (e.g., before or after initiation of) startup process 226. The privacy data may include other information such as computer instructions obtained (e.g., generated) by management controller 152 based on the privacy data (e.g., user settings) and/or the identified data privacy policy. The privacy data (e.g., the computer instructions) may, for example, be usable to manage operation of hardware resources 150 during startup process 226.

At interaction 228, the privacy data (and/or the other information) may be provided to hardware resources 150 by management controller 152. For example, the privacy data may be provided to hardware resources 150 over sideband communication channel 174A via (i) transmission via a message, (ii) storing in a storage with subsequent retrieval by hardware resources 150, (iii) a publish-subscribe system where hardware resources 150 subscribes to updates from management controller 152 thereby causing a copy of the privacy data to be propagated to hardware resources 150, and/or (iv) other processes. By providing the privacy data to hardware resources 150, management controller 152 may enforce compliance with the data privacy policy on hardware resources 150.

Hardware resources 150 may not include functionality for natively configuring execution flows (e.g., performed by a BIOS using portions of hardware resources 150) that may include privacy implicating processes. For example, hardware resources 150 may be unable to modify and/or otherwise configure an execution flow for startup process 226 based on the privacy data. Therefore, to enforce compliance with the data privacy policy on hardware resources 150, management controller 152 may, for example, modify an execution flow of startup process 226 based on the privacy data (e.g., when hardware resources 150 are unable to natively do so). To do so, management controller 152 may add, remove, and/or modify instructions of the execution flow, pause the execution flow, and/or otherwise manage the execution flow.

In a first example, management controller 152 may insert instructions usable for excluding a portion of startup process 226 from being performed into the execution flow. For example, startup process 226 may include a component validation process for data processing system 102, and when performed natively by hardware resources 150, the component validation process may provide component identifiers to a remote system for validation. However, the privacy data may indicate a limit on sharing of a portion of the component identifiers with the remote system; therefore, native compliance with the data privacy policy (e.g., regulations) may not be met. To comply with the data privacy policy, management controller 152 may modify the component validation process to exclude the portion of the component identifiers in accordance with the privacy data.

In a second example, if management controller 152 has identified that the privacy data for the user is stale, then management controller 152 may insert instructions usable for causing the user to be informed that the privacy data is potentially stale and to request authorization from the user to complete startup process 226. For example, the instructions may include instructions for presenting an interface to the user that provides a message requesting active consent from the user to perform startup process 226. The user may provide input to the interface that indicates that startup process 226 may proceed without adequate privacy data, or that startup process 226 should be aborted.

In a third example, management controller 152 may insert instructions usable for obtaining privacy data from the user prior to startup process 226 performing privacy implicating processes. For example, if management controller 152 cannot identify adequate (e.g., up-to-date, authentic) privacy data prior to performance of the component validation process, then an interface may be presented to the user during startup process 226 to obtain adequate privacy data.

Thus, management controller 152 may manage operation of hardware resources 150 via management of execution flows of hardware resources 150 based on the privacy data. By doing so, a likelihood of hardware resources 150 operating in compliance with data privacy policies and/or regulations may be improved.

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor-based devices (e.g., computer chips).

Any of the processes and interactions may be implemented using any type and number of data structures. The data structures may be implemented using, for example, tables, lists, linked lists, unstructured data, data bases, and/or other types of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

Thus, using processes and interactions shown in FIGS. 2A-2B, privacy data (e.g., user settings regarding use of regulated data) may be obtained and applied to enforce data privacy regulations on a data processing system in a secure and reliable manner using out-of-band methods. As data privacy regulations evolve (e.g., over time and/or based on geographical location) and/or as privacy data is updated by the user, the privacy data and/or data privacy policies for the data processing system may be reliably synchronized using the out-of-band methods. The data processing system may be more likely to comply with data privacy regulations than when relying on in-band methods. For example, the privacy data may be more likely to be reliable (e.g., up to date, authentic) and user intervention may be reduced to facilitate performance of compliant privacy implicating processes by the data processing system.

Turning to FIG. 3, a flow diagram illustrating a method in accordance with an embodiment is shown. The flow diagram may illustrate various operations performed while managing compliance of a data processing system with privacy regulations.

Prior to operation 300, the data processing system may (i) identify privacy data for the user, (ii) initiate storage of the privacy data by a remote system, and/or (iii) perform other actions for establishing the privacy data. For example, the privacy data may be identified by obtaining user input regarding limits on use of data subject to privacy regulations. The data subject to privacy regulations may include data that may be used by the data processing system and/or other entities during operation of the data processing system. Identifying the privacy data may include obtaining the privacy data based on the user input (e.g., receiving the privacy data, reading the privacy data from storage, and/or generating the privacy data).

Initiating storage of the privacy data may include (i) obtaining user permission for storage of the privacy data, (ii) providing the privacy data to a management controller of the data processing system (e.g., via an out-of-band communication channel), (iii) storing the privacy data in memory (e.g., so that the privacy data may be fetched by the management controller), (iv) providing the privacy data to the remote system (e.g., via an in-band communication channel), and/or (v) other methods. Refer to the discussion of FIG. 2A for more details regarding establishing privacy data.

At operation 300, privacy data for a user of the data processing system may be requested from a remote system via an out-of-band communication channel. The privacy data may be requested by using methods described with respect to interaction 222 of FIG. 2B and/or by other methods. For example, a management controller of the data processing system may generate a request for the privacy data and provide the request to the remote system via the out-of-band communication channel.

The request may be provided to the remote system while hardware resources of the data processing system are unpowered. To do so, for example, the management controller may manage power distribution to portions of the hardware resources (e.g., a network card) in order to facilitate transmission of the request to the remote system.

At operation 302, the privacy data may be obtained from the remote system via the out-of-band communication channel. The privacy data may be obtained by using methods described with respect to interaction 224 of FIG. 2B and/or by other methods. For example, the management controller may obtain the privacy data from the remote system (e.g., service system 104) via the out-of-band communication channel.

The privacy data may indicate limits on use of data subject to privacy regulations (e.g., data privacy regulations), and the privacy regulations may be enforced on the hardware resources when the hardware resources are unable to natively enforce the privacy regulations (e.g., during a startup process of the data processing system).

The privacy data may be obtained by the management controller while hardware resources of the data processing system are unpowered. To do so, for example, the management controller may manage power distribution to the network card in order to facilitate receiving the privacy data from the remote system.

At operation 304, compliance of the hardware resources with the privacy regulations may be enforced during operation of the hardware resources in which native compliance with the privacy regulations is not met. Compliance may be enforced by (i) providing the privacy data to the hardware resources (e.g., refer to interaction 228 of FIG. 2B), (ii) modifying an execution flow of a data privacy implicating process (e.g., a startup process) for the hardware resources based on the privacy data, (iii) pausing and/or resuming the execution flow, (iv) aborting (portions of) the execution flow, and/or (v) performing other actions to manage operation of the hardware resources. For example, management controller 152 may generate instructions usable to modify the execution flow based on the privacy data.

Modifying the execution flow may include inserting the instructions into the execution flow. In a first example, the instructions may be usable for obtaining the privacy data from the user prior to the startup process (or another privacy implicating process) using the data subject to the privacy regulations. In a second example, the instructions may be usable to exclude a portion of the startup process (or another privacy implicating process) that uses the data subject to the privacy regulations in a manner that violates the privacy regulations. In a third example, the instructions may be usable to cause the user to be informed that the privacy data is potentially stale, and/or to request authorization from the user to complete the startup process nominally (e.g., without modification with respect to the privacy data).

Inserting the instructions may include from the user may include (i) identifying a position in the execution flow (e.g., prior to use of the data subject to the privacy regulations), (ii) pausing the execution flow before instructions at the position are executed, (iii) inserting the instructions (e.g., for interfacing with the user, for excluding a portion of the execution flow), and/or (iii) resuming the execution flow so that the inserted instructions may be executed.

For example, the management controller may modify (e.g., insert instructions into) the execution flow to monitor and/or manage (e.g., control) activity of the hardware resources using sideband communication channels. Enforcing compliance of the hardware resources with the privacy regulations may include facilitating a computer-implemented service that is in compliance with the privacy regulations.

The method may end following operation 304.

Thus, as illustrated above, embodiments disclosed herein may provide systems and methods for managing (operation of) a data processing system in a manner that increases a likelihood of compliance with data privacy regulations. By using out-of-band methods to manage privacy data and/or enforcement of relevant policies for the data processing system, reliance on potentially compromised and/or inoperable hardware resources of the data processing system may be reduced.

Any of the components illustrated in FIGS. 1A-3 may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as Vx Works.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMAX transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid-state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs, or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components, or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing a data processing system, the method comprising:
requesting, by a management controller of the data processing system and via an out-of-band communication channel, privacy data for a user of the data processing system from a remote system, the privacy data indicating limits on use of data subject to privacy regulations to be enforced on hardware resources of the data processing system while the hardware resources are unable to natively enforce the privacy regulations;
obtaining, by the management controller and via the out-of-band communication channel, the privacy data from the remote system; and
enforcing, by the management controller, compliance of the hardware resources with the privacy regulations during operation of the hardware resources in which native compliance with the privacy regulations is not met.

2. The method of claim 1, further comprising:
prior to requesting the privacy data:
identifying, by the data processing system, the privacy data for the user, and
initiating, by the data processing system, storage of the privacy data by the remote system.

3. The method of claim 2, wherein the privacy data is provided to the remote system by the management controller using the out-of-band communication channel.

4. The method of claim 1, wherein enforcing the compliance comprises:
modifying, by the management controller, an execution flow of a startup process for the hardware resources based on the privacy data.

5. The method of claim 4, wherein the hardware resources of the data processing system are unable to natively modify the execution flow based on the privacy data.

6. The method of claim 4, wherein modifying the execution flow comprises:
inserting, by the management controller, instructions into the execution flow, the instructions being usable for obtaining the privacy data from the user prior to the startup process using the data subject to the privacy regulations.

7. The method of claim 4, wherein modifying the execution flow comprises:
inserting, by the management controller, instructions into the execution flow, the instructions being usable to exclude a portion of the startup process from being performed, the portion of the startup process using the data subject to the privacy regulations in a manner that violates the privacy regulations.

8. The method of claim 4, wherein modifying the execution flow comprises:
inserting, by the management controller, instructions into the execution flow, the instructions being usable to cause the user to be informed that the privacy data is potentially stale, and request authorization from the user to complete the startup process.

9. The method of claim 1, wherein the data processing system comprises a network module adapted to separately advertise network endpoints for the management controller and the hardware resources, the network endpoints being usable by the remote system to address communications to the hardware resources and the management controller.

10. The method of claim 9, wherein the out-of-band communication channel runs through the network module, and an in-band communication channel that services the hardware resources also runs through the network module.

11. The method of claim 9, wherein the management controller and the network module are on separate power domains from the hardware resources so that the management controller and the network module are operable while the hardware resources are inoperable.

12. The method of claim 11, wherein the requesting and the obtaining are performed while the hardware resources are inoperable due to being unpowered.

13. A non-transitory machine-readable medium having instructions stored therein, which when executed by a processor, cause the processor to perform operations for managing a data processing system, the operations comprising:
requesting, by a management controller of the data processing system and via an out-of-band communication channel, privacy data for a user of the data processing system from a remote system, the privacy data indicating limits on use of data subject to privacy regulations to be enforced on hardware resources of the data processing system while the hardware resources are unable to natively enforce the privacy regulations;
obtaining, by the management controller and via the out-of-band communication channel, the privacy data from the remote system; and
enforcing, by the management controller, compliance of the hardware resources with the privacy regulations during operation of the hardware resources in which native compliance with the privacy regulations is not met.

14. The non-transitory machine-readable medium of claim 13, wherein the operations further comprise:
prior to requesting the privacy data:
identifying, by the data processing system, the privacy data for the user, and initiating, by the data processing system, storage of the privacy data by the remote system.

15. The non-transitory machine-readable medium of claim 14, wherein the privacy data is provided to the remote system by the management controller using the out-of-band communication channel.

16. The non-transitory machine-readable medium of claim 13, wherein enforcing the compliance comprises:
modifying, by the management controller, an execution flow of a startup process for the hardware resources based on the privacy data.

17. A data processing system, comprising:
a processor; and
a memory coupled to the processor to store instructions, which when executed by the processor, cause operations for managing the data processing system to be performed, the operations comprising:
requesting, by a management controller of the data processing system and via an out-of-band communication channel, privacy data for a user of the data processing system from a remote system, the privacy data indicating limits on use of data subject to privacy regulations to be enforced on hardware resources of the data processing system while the hardware resources are unable to natively enforce the privacy regulations,
obtaining, by the management controller and via the out-of-band communication channel, the privacy data from the remote system, and
enforcing, by the management controller, compliance of the hardware resources with the privacy regulations during operation of the hardware resources in which native compliance with the privacy regulations is not met.

18. The data processing system of claim 17, wherein the operations further comprise:
prior to requesting the privacy data:
identifying, by the data processing system, the privacy data for the user, and
initiating, by the data processing system, storage of the privacy data by the remote system.

19. The data processing system of claim 18, wherein the privacy data is provided to the remote system by the management controller using the out-of-band communication channel.

20. The data processing system of claim 17, wherein enforcing the compliance comprises:
modifying, by the management controller, an execution flow of a startup process for the hardware resources based on the privacy data.
